(19) United States
(12) Patent Application Publication
(10) Pub. No.: US 2015/0231900 A1
(43) Pub. Date: Aug. 20, 2015

(54) METHOD FOR FORMING AN INKJET IMAGE

(71) Applicant: OCE-TECHNOLOGIES B.V., Venlo (NL)

(72) Inventors: Robert W.M. SEVERT, Eindhoven (NL); Martinus J. HUIJBEN, Grubbenvorst (NL); Henricus C.M. KRIJNEN, Asten (NL)

(73) Assignee: OCE-TECHNOLOGIES B.V., Venlo (NL)

(21) Appl. No.: 14/703,571

(22) Filed: May 4, 2015

Related U.S. Application Data
(63) Continuation of application No. PCT/EP2013/072931, filed on Nov. 4, 2013.

(30) Foreign Application Priority Data
Nov. 5, 2012 (EP) 12191237.2

(51) Int. Cl. B41J 11/04

(52) U.S. Cl. CPC B41J 11/04

(57) ABSTRACT

A printer for forming an inkjet image has an advance mechanism for a print substrate. The printer includes an advance mechanism for moving a print substrate in a transport direction. The advance mechanism includes a feed roller engaging the print substrate on a first surface of the print substrate for applying a driving force thereto and a pressure roller, being arranged opposite to the feed roller. The pressure roller has a textured outer surface which texture is in operation in rolling contact with a second surface of the print substrate. The texture of the outer surface is provided with a plurality of protrusions. The pressure roller diminishes print artifacts, which are related to an irregular crystallization of the hot melt ink.

### FIELD OF THE INVENTION

The present invention relates to a hot melt printer for forming an inkjet image having an advance mechanism for a print substrate. The present invention further relates to a method for forming an inkjet image. The present invention further relates to an advance mechanism for a print substrate for use in a hot melt inkjet apparatus.

### BACKGROUND OF THE INVENTION

In a scanning-type printer for printing a hot melt ink, a feed nip is frequently used for advancing a sheet of paper or any other print substrate in a specified direction past a print head, so that the print substrate is scanned with the print head. The print head is positioned downstream of the feed nip. The feed nip is defined by a feed roller for driving the sheet and a pressure roller. The speed or the length of the advance steps with which the sheet is moved relative to the print head must accordingly be controlled with high accuracy, in order to obtain a good image quality. For example, in a typical set-up of an inkjet printer, a multi-nozzle print head is mounted on a carriage which travels across the print substrate sheet in a main scanning direction normal to the direction of sheet advance, so that an image swath of several pixel lines is printed on the sheet in each pass of the print head. Then, the sheet is advanced by the feed nip over the width of the swath, so that the next swath can be printed in a position precisely adjoining to the previous swath.

The pressure roller of the feed nip has typically a smooth rubber outer surface, which is in rolling contact with a surface of the print substrate, on which surface the inkjet image is formed downstream of the feed nip. It has been found that print artifacts are visible in the inkjet image in an area of the surface of the print substrate, which area is contacted by the pressure roller before the hot melt ink is applied on top of the surface of the print substrate. In particular it is observed that in this area the gloss of the inkjet image is disturbed due to an irregular crystallization pattern of the hot melt ink. The irregular crystallization pattern of the ink on a micro scale becomes visible as gloss banding of the inkjet image on a macro scale. The pressure roller is believed to deform and/or contaminate the surface of the print substrate on a micro scale.

### SUMMARY OF THE INVENTION

It is accordingly an object of the present invention to provide a printer for forming an inkjet image using a hot melt ink, the printer having an advance mechanism for a print substrate, wherein the above problem has been mitigated.

This object is attained by a printer for forming an inkjet image having an advance mechanism for moving a print substrate in a transport direction, the advance mechanism comprising a feed roller engaging the print substrate on a first surface of the print substrate for applying a driving force thereto and a pressure roller, being arranged opposite to the feed roller, the pressure roller having a textured outer surface, which texture is in operation in rolling contact with a second surface of the print substrate, wherein the texture of the outer surface is provided with a plurality of protrusions, wherein the textured outer surface of the pressure roller comprises an assembly of spherical segments, the spherical segments in the assembly being arranged adjacent to each other, wherein the plurality of protrusions is provided by the outer surface of the assembly of spherical segments, the hot melt printer further comprising a print station for providing the inkjet image on the second surface of the print substrate, which print station is arranged downstream of the advance mechanism.

The plurality of protrusions provide in operation a plurality of small contact areas with the second surface of the print substrate compared to a smooth outer surface providing a single large contact area. It has been found that the print artifacts, which are related to an irregular crystallization of the hot melt ink, have been diminished by the textured outer surface of the pressure roller.

Preferably the protrusions extend at least 50 microns. As a result it is found that the small contact areas are relatively constant in time and do not substantially increase. In case the protrusions are smaller than 50 microns a non-contact area adjacent to a contact area may be filled up due to contaminations, such as paper dust.

In an embodiment of the printer, the printer is a hot melt inkjet printer. It has in particular been found that the print artifacts, which are related to an irregular crystallization of the hot melt ink of the hot melt inkjet printer, have been diminished by the textured outer surface of the pressure roller.

In an embodiment of the printer, the pressure roller comprises a film, which film provides the textured outer surface. The film may be easily attached to the outer surface of the pressure roller, for example by using an adhesive. The outer film (or outer surface layer) may provide the texture of the textured outer surface independently of a base roller of the pressure roller. In this way a simple and quick assembly can be made of an ordinary pressure roller, having a smooth outer surface, and a textured film, thereby effectively adapting the outer surface of the pressure roller according to the invention.

In the printer according to the invention, the textured outer surface of the pressure roller comprises an assembly of spherical segments, the spherical segments in the assembly being arranged adjacent to each other, wherein the plurality of protrusions is provided by the outer surface of the assembly of spherical segments. The spherical segments may be balls, beads, half of balls or any other globular shapes, which provide a defined contact area. The spherical segments provide a defined contact area independent of a variation of contact pressure in the feed nip of the advancing mechanism.

In a further embodiment of the printer, the textured outer surface of the pressure roller comprises an assembly of beads, each bead being substantially spherical, the beads in the assembly being arranged adjacent to each other, and wherein the plurality of protrusions is provided by the outer surface of the assembly of beads. The beads in the assembly are preferably arranged in a single layer providing a dense packing of the beads. The packing of the beads may be regular, such as a matrix, and may be irregular as a regular packing is not necessarily for the present invention. The beads may be glass beads, may be metal beads and may be constituted by any other relatively hard material, which is suitable to provide a spherical shape. It has been found that the texture of the assembly of beads reduces the print artifacts more than a texture provided by a rough surface comprising small spiky elements, having sharp projections. In particular sharp projections have found to easily intrude or damage a print substrate, thereby disturbing a crystallization pattern of the hot melt ink.

In a further embodiment of the printer, the beads have a mean diameter in the range between 0.05 mm and 0.8 mm, more preferably the mean diameter being in the range between 0.1 mm and 0.4 mm. The lower limit of the range (e.g. 0.05 mm) is restricted as in the long term the beneficial effect of texture is lost, probably due to a filling up of the spaces between the beads by contaminations. The upper limit of the range is restricted as the print artifacts become more or less visible, wherein the upper limit of the range depends among others on the printing mode (e.g. high quality mode versus high productivity mode) and the selection of the print substrate.

In an embodiment of the printer, the feed roller is adapted to advance the substrate intermittently in the transport direction over a print surface of the print station.

In an embodiment of the printer, the advance mechanism comprises a plurality of pressure rollers, each of the pressure rollers having a textured outer surface which is in operation in rolling contact with the second surface of the print substrate.

In another aspect of the invention a method is provided for forming an hot melt inkjet image in an inkjet printing apparatus, comprising the steps: supplying a print substrate from a supply unit to a print station; advancing the print substrate through a nip between a feed roller and a pressure roller, wherein the pressure roller has a textured outer surface, which texture is in rolling contact with a second surface of the print substrate, wherein the texture of the outer surface is provided with a plurality of protrusions, wherein the textured outer surface of the pressure roller comprises an assembly of spherical segments, the spherical segments in the assembly being arranged adjacent to each other, wherein the plurality of protrusions is provided by the outer surface of the assembly of spherical segments; and providing an inkjet image on the second surface of the print substrate.

In the advancing step the pressure roller is adapted for not intruding the second surface of the print substrate. In particular the plurality of protrusions of the pressure roller is adapted for not intruding the second surface of the print substrate during the advancing step.

In another aspect of the invention an advancing mechanism is provided for a print substrate for use in a hot melt inkjet apparatus, the advancing mechanism comprising a feed roller engaging the print substrate on a first surface of the print substrate for applying a driving force thereto and a pressure roller, being arranged opposite to the feed roller, the pressure roller having a textured outer surface, which texture is in operation in rolling contact with a second surface of the print substrate, wherein the texture of the outer surface is provided with a plurality of protrusions.

In an embodiment of the advancing mechanism, the feed roller is adapted to advance the substrate intermittently in the transport direction over a print surface of a print station, which print station is arranged downstream of the advance mechanism.

In another aspect of the invention a use is provided of an advancing mechanism for not disturbing a crystallization pattern of a hot melt ink on a print substrate, wherein the advancing mechanism is adapted for driving said print substrate upstream of a print station being adapted for printing said hot melt ink on said print substrate downstream of the advancing mechanism, the advancing mechanism comprising a feed roller engaging the print substrate on a first surface of the print substrate for applying a driving force thereto and a pressure roller, being arranged opposite to the feed roller, the pressure roller having a textured outer surface, which texture is in operation in rolling contact with a second surface of the print substrate, wherein the texture of the outer surface is provided with a plurality of protrusions.

The plurality of protrusions is adapted for not intruding the second surface of the print substrate. The texture of the outer surface of the pressure roller of the advancing mechanism has the advantage that a crystallization pattern of a hot melt ink on the print substrate is not disturbed.

In U.S. Pat. No. 5,320,024 a paper web guide roller is disclosed for use with a rotary printing machine to guide freshly printed paper web. In U.S. Pat. No. 5,320,024 it is disclosed that freshly printed paper webs are guided in such a way that the freshly printed surface contacts the guide roller. The use of the guide roller is to prevent deposit of ink on the surface.

As used herein the printer for forming an inkjet image may be a hot melt inkjet printer, wherein the ink solidifies by crystallization and may be a radiation curable hot melt inkjet printer, wherein the radiation curable hot melt ink may comprise a crystallizing component or a gelling phase forming component, and wherein the radiation curable hot melt ink may be hardened by curing any radiation curable components of the radiation curable hot melt ink.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying schematical drawings which are given by way of illustration only, and thus are not limitative of the present invention, and wherein:

FIG. 1A shows an image forming apparatus, wherein printing is achieved using a wide format inkjet printer.

FIG. 1B shows an ink jet printing assembly.

FIG. 2 is a diagram of a printer according to an embodiment of the present invention.

FIG. 3A shows a cross section of an embodiment of the pressure roller according to the present invention.

FIG. 3B illustrates an enlarged portion E of the outer surface layer of the pressure roller shown in FIG. 3A.

FIG. 4A illustrates a crystal size distribution of type A, providing the reference gloss level of the image.

FIG. 4B illustrates a crystal size distribution of type C, wherein the gloss of the image is visibly diminished.

FIG. 4C illustrates a crystal size distribution of type B, wherein effects on gloss level become slightly visible in the image.

### DETAILED DESCRIPTION OF EMBODIMENTS

The present invention will now be described with reference to the accompanying drawings, wherein the same reference numerals have been used to identify the same or similar elements throughout the several views.

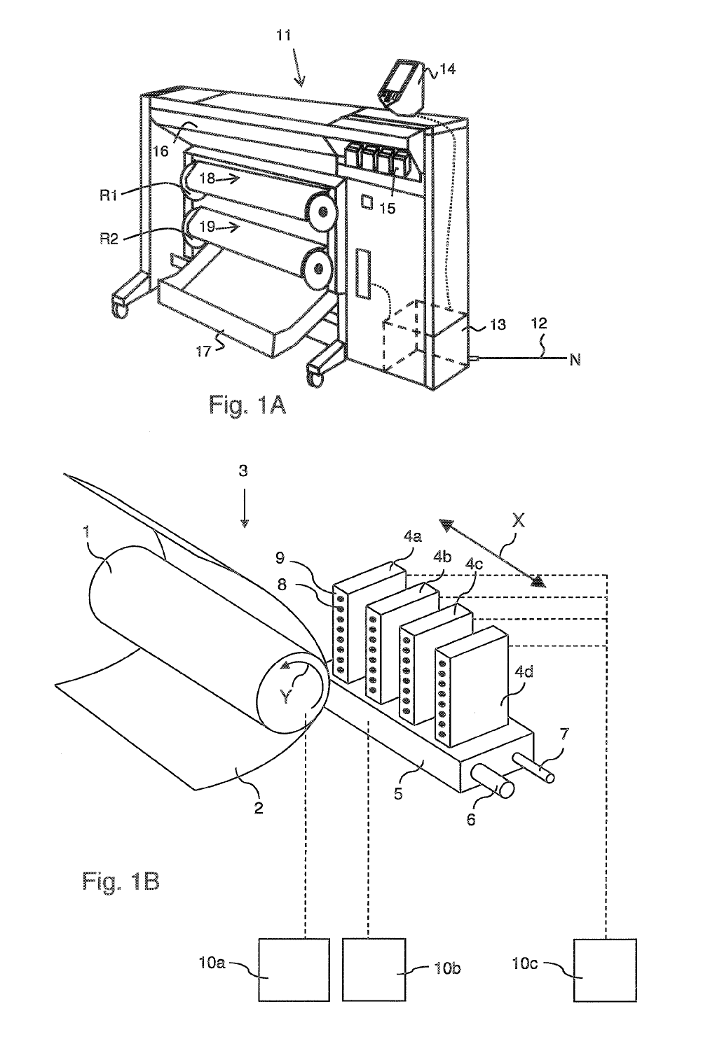

FIG. 1A shows an image forming apparatus 11, wherein printing is achieved using a wide format inkjet printer. The wide-format image forming apparatus 11 comprises a housing 16, wherein the printing assembly, for example the ink jet printing assembly shown in FIG. 1B is placed. The image forming apparatus 11 also comprises a storage means for storing image receiving member 18, 19, a delivery station to collect the image receiving member 18, 19 after printing and storage means for marking material 15. In FIG. 1A, the delivery station is embodied as a delivery tray 17. Optionally, the delivery station may comprise processing means for processing the image receiving member 18, 19 after printing, e.g. a folder or a puncher. The wide-format image forming apparatus 11 furthermore comprises means for receiving print jobs and optionally means for manipulating print jobs. These means may include a user interface unit 14 and/or a control unit 13, for example a computer.

Images are printed on an image receiving member, for example paper, supplied by a roll 18, 19. The roll 18 is supported on the roll support R1, while the roll 19 is supported on the roll support R2. Alternatively, cut sheet image receiving members may be used instead of rolls 18, 19 of image receiving member. Printed sheets of the image receiving member, cut off from the roll 18, 19, are deposited in the delivery tray 17.

Each one of the marking materials for use in the printing assembly are stored in four containers 15 arranged in fluid connection with the respective print heads for supplying marking material to said print heads.

The local user interface unit 14 is integrated to the print engine and may comprise a display unit and a control panel. Alternatively, the control panel may be integrated in the display unit, for example in the form of a touch-screen control panel. The local user interface unit 14 is connected to a control unit 13 placed inside the printing apparatus 11. The control unit 13, for example a computer, comprises a processor adapted to issue commands to the print engine, for example for controlling the print process. The image forming apparatus 11 may optionally be connected to a network N. The connection to the network N is diagrammatically shown in the form of a cable 12, but nevertheless, the connection could be wireless. The image forming apparatus 11 may receive printing jobs via the network. Further, optionally, the controller of the printer may be provided with a USB port, so printing jobs may be sent to the printer via this USB port.

FIG. 1B shows an ink jet printing assembly 3. The ink jet printing assembly 3 comprises supporting means for supporting an image receiving member 2. The supporting means are shown in FIG. 1B as a platen 1, but alternatively, the supporting means may be a flat surface. The platen 1, as depicted in FIG. 1B, is a rotatable drum, which is rotatable about its axis as indicated by arrow A. The supporting means may be optionally provided with suction holes for holding the image receiving member in a fixed position with respect to the supporting means. The ink jet printing assembly 3 comprises print heads 4a-4d, mounted on a scanning print carriage 5. The scanning print carriage 5 is guided by suitable guiding means 6, 7 to move in reciprocation in the main scanning direction B. Each print head 4a-4d comprises an orifice surface 9, which orifice surface 9 is provided with at least one orifice 8. The print heads 4a-4d are configured to eject droplets of marking material onto the image receiving member 2. The platen 1, the carriage 5 and the print heads 4a-4d are controlled by suitable controlling means 10a, 10b and 10c, respectively.

The image receiving member 2 may be a medium in web or in sheet form and may be composed of e.g. paper, cardboard, label stock, coated paper, plastic or textile. Alternatively, the image receiving member 2 may also be an intermediate member, endless or not. Examples of endless members, which may be moved cyclically, are a belt or a drum. The image receiving member 2 is moved in the sub-scanning direction A by the platen 1 along four print heads 4a-4d provided with a fluid marking material.

A scanning print carriage 5 carries the four print heads 4a-4d and may be moved in reciprocation in the main scanning direction B parallel to the platen 1, such as to enable scanning of the image receiving member 2 in the main scanning direction B. Only four print heads 4a-4d are depicted for demonstrating the invention. In practice an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving member 2. For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a-4d, containing a differently colored marking material.

The carriage 5 is guided by guiding means 6, 7. These guiding means 6, 7 may be rods as depicted in FIG. 1B. The rods may be driven by suitable driving means (not shown). Alternatively, the carriage 5 may be guided by other guiding means, such as an arm being able to move the carriage 5. Another alternative is to move the image receiving material 2 in the main scanning direction B.

Each print head 4a-4d comprises an orifice surface 9 having at least one orifice 8, in fluid communication with a pressure chamber containing fluid marking material provided in the print head 4a-4d. On the orifice surface 9, a number of orifices 8 is arranged in a single linear array parallel to the sub-scanning direction A. Eight orifices 8 per print head 4a-4d are depicted in FIG. 1B, however obviously in a practical embodiment several hundreds of orifices 8 may be provided per print head 4a-4d, optionally arranged in multiple arrays. As depicted in FIG. 1B, the respective print heads 4a-4d are placed parallel to each other such that corresponding orifices 8 of the respective print heads 4a-4d are positioned in-line in the main scanning direction B.

This means that a line of image dots in the main scanning direction B may be formed by selectively activating up to four orifices 8, each of them being part of a different print head 4a-4d. This parallel positioning of the print heads 4a-4d with corresponding in-line placement of the orifices 8 is advantageous to increase productivity and/or improve print quality. Alternatively multiple print heads 4a-4d may be placed on the print carriage adjacent to each other such that the orifices 8 of the respective print heads 4a-4d are positioned in a staggered configuration instead of in-line. For instance, this may be done to increase the print resolution or to enlarge the effective print area, which may be addressed in a single scan in the main scanning direction. The image dots are formed by ejecting droplets of marking material from the orifices 8.

Upon ejection of the marking material, some marking material may be spilled and stay on the orifice surface 9 of the print head 4a-4d. The ink present on the orifice surface 9 may negatively influence the ejection of droplets and the placement of these droplets on the image receiving member 2. Therefore, it may be advantageous to remove excess of ink from the orifice surface 9. The excess of ink may be removed for example by wiping with a wiper and/or by application of a suitable anti-wetting property of the surface, e.g. provided by a coating.

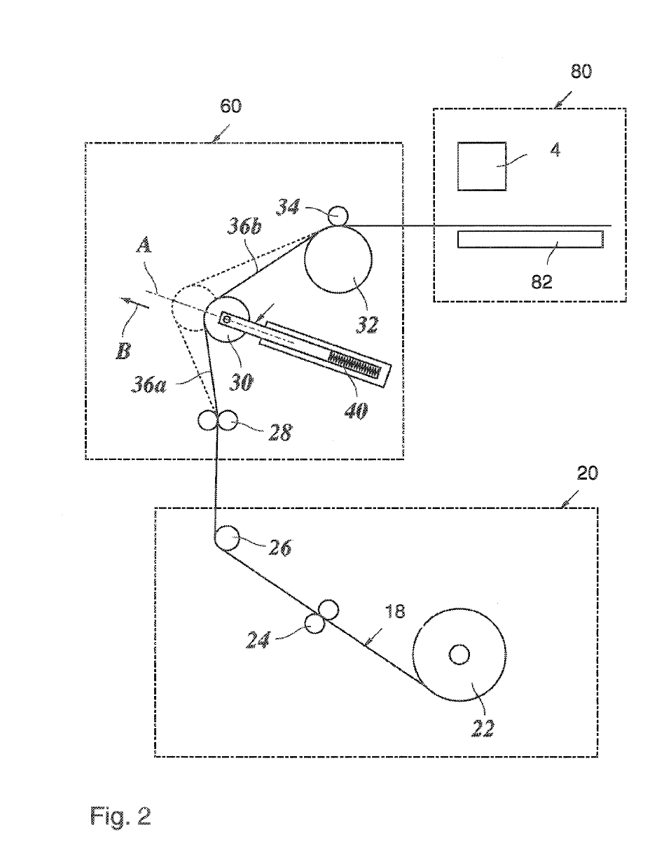

FIG. 2 is a diagram of a printer according to an embodiment of the present invention. The printer shown in FIG. 2 comprises a supply unit 20, a transport unit 60 and a print station 80. The supply unit 20 serves for the storage and delivery of a substrate 18 for printing. The transport unit 60 transports the substrate 18 from the supply unit 20 to the print station 80 and also provides for accurate positioning of the substrate in a print zone in the print station. In this embodiment, the print station 80 is a conventional ink jet engine which comprises a print head 4 arranged above a print surface 82 and adapted to move back and forth across the substrate 18 on the print surface 82 in a direction normal to the plane of the drawing in FIG. 2. The print head 4 has only a limited printing range, so that it is necessary to print the image on the substrate in different sub-images. To this end, the substrate 18 is advanced intermittently, and a sub-image or swath is printed in each interval between two subsequent advance steps. The increments by which the substrate 18 is advanced over the print surface 82 are precisely controlled, so that the sub-images will exactly adjoin to one another.

In the example shown, the substrate 18 comes from a roll 22 that is rotatably supported in the supply unit 20. The substrate 18 has the form of a web having a length 150 m, for example, that is wound on the roll 22. In the example shown, the printer is a large format printer, and the width of the web corresponds to the smaller side of a document in AO format. A pair of drive rollers 24 serves for drawing the substrate 18 off from the roll 22. The web drawn off from the roll is passed over a deflection roller 26 and is then paid out towards the transport unit 60.

In the transport unit 60, the web-type print substrate passes through a nip between a pair of rollers 28 forming a first feed unit, is deflected at a guide member 30 and is then passed on towards a feed nip of a second feed unit comprising a driven feed roller 32 and a pressure roller 34. The driven feed roller 32 controls the length of the increments with which the substrate 18 is advanced over the print surface 82.

A portion of the substrate 18 adjoining the feed roller 32 on the upstream side is divided by the guide member 30 into two sub-portions 36a, 36b forming an angle with one another. The guide member 30, which may be a roller or a stationary member, is movable along an axis A bisecting the angle between the sub-portions 36a and 36b and the guide member is elastically biased in a direction indicated by an arrow B, so that the substrate portion 36a, 36b is held under a certain tension. Thus, the movable guide member 30 and its guide and biasing mechanism serve as a tensioning mechanism 38. In FIG. 1 the elastic bias of the guide member 30 has been symbolized by a compression spring 40.

In view of the fact that, on the one hand, the substrate 18 is advanced intermittently by the feed roller 32 and, on the other hand, the roll 22 in the supply unit 20 may have a considerable moment of inertia, so that large forces are required for accelerating and decelerating the same, one of the functions of the tensioning mechanism 38 in the transport unit 60 is to provide a buffer in the feed path of the web and to protect the web against successive strains. This buffer action may for example be accomplished as follows. When the feed roller 32 stops, the guide member 30 will be in the extended position shown in phantom lines in FIG. 1, so that the length of the substrate portion 36a, 36b is comparatively large. Then, when a new advance step commences, the feed roller 32 starts to rotate with a comparatively large acceleration, whereas the roller pairs 24 and 28 accelerate the web with a smaller acceleration. As a result, a part of the length of the substrate portion 36a, 36b will be consumed, and the guide member 30 is moved against the biasing force of the spring 40 towards the position shown in continuous lines in FIG. 2. Conversely, at the end of the advance step, the feed roller 32 will be stopped relatively abruptly, whereas the roller pairs 24 and 28 will decelerate the web with a moderate deceleration. Consequently, the guide member 30 will move back towards the position shown in phantom lines, so as to eliminate a possible slack in the substrate portion 36a, 36b.

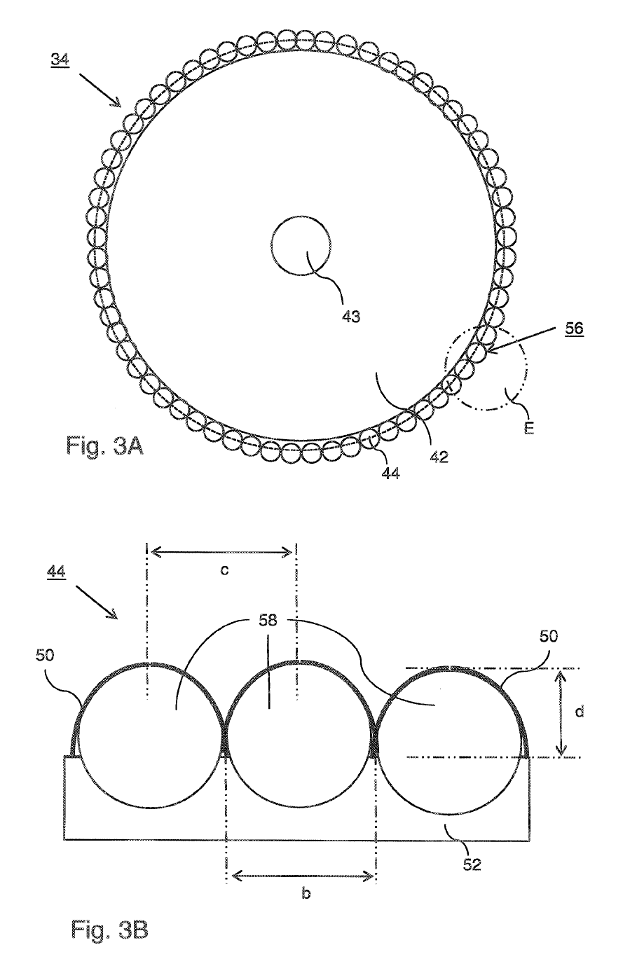

In the present invention the pressure roller 34 has a textured outer surface, which outer surface is in rolling contact with a second surface of the print substrate. In FIG. 3A is shown a cross section of an embodiment of the pressure roller according to the present invention. The Pressure roller 34 comprises a base roller 42 and an outer surface layer 44 (or film). The base roller 42 is freely rotatable mounted around axis 43. The outer surface layer 44 comprises an assembly of glass beads 56.

FIG. 3B illustrates an enlarged portion E of the outer surface layer of the pressure roller shown in FIG. 3A. Each glass bead 58 is substantially spherical. The diameter of the glass bead 58 is indicated by arrow b. The beads in the assembly 46 are arranged adjacent to each other, thereby forming a single layer of beads having a dense matrix packing. Each of the beads 58 provides a small contact area with a print substrate. The distance between adjacent contact areas is schematically indicated by arrow c. The assembly of beads 56 is coated by a single layer coating 50, which is substantially conformal to the outer surface of the glass beads 58, or is coated by a multiple layer coating structure. The single layer coating 50 is a silicon coating, an adhesive coating, or any other suitable coating for retaining the glass beads 58 in the assembly of beads 56. The multiple layers coating structure (not shown) comprises a silicon coating, preferably a silicon top coating, an adhesive coating, and optionally a primer coating for bonding the silicon top coating to the adhesive coating. Any of the coatings may optionally provide an ink and/or oil resistant layer. The assembly of beads 56 is embedded in a base layer 52, which provides adhesion to the beads 58. Each of the beads 58 provides a protrusion which extends from the base layer 52 over a distance as indicated by arrow d. The base layer 52 further provides flexibility to the surface layer 44. This is for example useful when the surface layer 44 is handled in the form of a film when being applied onto the outer surface of the base roller 34.

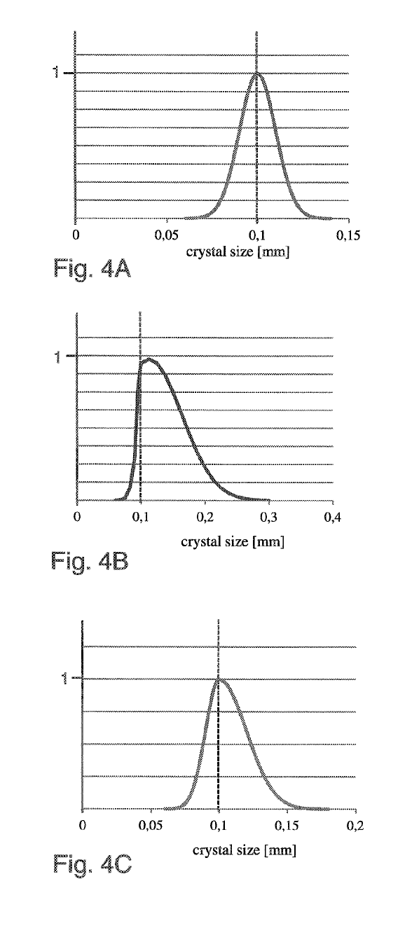

The glass beads 58 in the assembly of glass beads 56 have a mean diameter in the range between 0.05 mm and 0.8 mm. In table I is shown how the mean diameter of the glass beads effects the crystal size distribution of the hot melt ink image in an area which has been contacted by the pressure roller. A reference gloss level is provided by a crystal size distribution shown in FIG. 4A for an area of the inkjet image, which area of the print substrate has not been contacted by the pressure roller 34. The crystal size distribution is symmetrical around crystal size 0.1 mm (type A).

In case a pressure roller 34 has a smooth outer surface, the crystal size distribution is asymmetric as is shown in FIG. 4B, wherein larger crystals are formed having crystal sizes up to 0.3 mm (type C). The gloss of the image is visibly diminished.

The crystal size distribution is not affected by a pressure roller 34 and is similar to the symmetrical distribution shown in FIG. 4A, in case the glass bead size is in the range between 0.1 mm and 0.4 mm (type A). No effects on gloss marks are seen. The crystal size distribution becomes slightly affected by a pressure roller 34 in case the glass bead size is around 0.05 mm or is around 0.8 mm (type B). In this case the crystal size distribution is slightly asymmetrical, having some crystals larger than 0.15 mm as is shown in FIG. 4C. Effects on gloss level become slightly visible.

TABLE I
crystallization distribution type depending on glass
bead size used to texture the outer surface of the pressure roller

| Glass bead size | Crystal distribution |
|---|---|
| [mm] | type |
| <0.05 | C |
| 0.05 | B |
| 0.1 | A |
| 0.2 | A |
| 0.3 | A |
| 0.4 | A |
| 0.8 | B |
| >0.8 | C |

The glass beads provide a defined contact area with the print substrate. The glass beads also prevent an intrusion of the surface of the print substrate. A person skilled in the art may easily contemplate similar globular and/or spherical segments which could provide a suitable textured outer surface as disclosed in the present invention.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims is herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A printer for forming an inkjet image having an advance mechanism for moving a print substrate in a transport direction, the advance mechanism comprising a feed roller engaging the print substrate on a first surface of the print substrate for applying a driving force thereto and a pressure roller, being arranged opposite to the feed roller, the pressure roller having a textured outer surface, which texture is in operation in rolling contact with a second surface of the print substrate, wherein the texture of the outer surface is provided with a plurality of protrusions, wherein the textured outer surface of the pressure roller comprises an assembly of spherical segments, the spherical segments in the assembly being arranged adjacent to each other, wherein the plurality of protrusions is provided by the outer surface of the assembly of spherical segments, the printer further comprising a print station for providing the inkjet image on the second surface of the print substrate, which print station is arranged downstream of the advance mechanism.

2. The printer according to claim 1, wherein the printer is a hot melt inkjet printer.

3. The printer according to claim 1, wherein the pressure roller comprises a film, which film provides the textured outer surface.

4. The printer according to claim 1, wherein the textured outer surface of the pressure roller comprises an assembly of beads, each bead being substantially spherical, the beads in the assembly being arranged adjacent to each other, and wherein the plurality of protrusions is provided by the outer surface of the assembly of beads.

5. The printer according to claim 4, wherein the beads have a mean diameter in the range between 0.05 and 0.8 mm.

6. The printer according to claim 1, wherein the feed roller is adapted to advance the substrate intermittently in the transport direction over a print surface of the print station.

7. The printer according to claim 1, wherein the advance mechanism comprises a plurality of pressure rollers, each of the pressure rollers having a textured outer surface which is in operation in rolling contact with the second surface of the print substrate.

8. A method for forming an inkjet image in an hot melt inkjet printing apparatus, comprising the steps:
a) supplying a print substrate from a supply unit to a print station;
b) advancing the print substrate through a nip between a feed roller and a pressure roller, wherein the pressure roller has a textured outer surface, which texture is in rolling contact with a second surface of the print substrate, wherein the texture of the outer surface is provided with a plurality of protrusions, wherein the textured outer surface of the pressure roller comprises an assembly of spherical segments, the spherical segments in the assembly being arranged adjacent to each other, wherein the plurality of protrusions is provided by the outer surface of the assembly of spherical segments;
c) providing an inkjet image on the second surface of the print substrate downstream of the nip between the feed roller and the pressure roller.

9. An advancing mechanism for a print substrate for use in a hot melt inkjet apparatus, the advancing mechanism comprising a feed roller engaging the print substrate on a first surface of the print substrate for applying a driving force thereto and a pressure roller, being arranged opposite to the feed roller, the pressure roller having a textured outer surface, which texture is in operation in rolling contact with a second surface of the print substrate, wherein the texture of the outer surface is provided with a plurality of protrusions and wherein the textured outer surface of the pressure roller comprises an assembly of spherical segments, the spherical segments in the assembly being arranged adjacent to each other, wherein the plurality of protrusions is provided by the outer surface of the assembly of spherical segments.

10. The advancing mechanism according to claim 9, wherein the feed roller is adapted to advance the substrate intermittently in the transport direction over a print surface of a print station, which print station is arranged downstream of the advance mechanism.

11. A method, comprising:
using an advancing mechanism for not disturbing a crystallization pattern of a hot melt ink on a print substrate, wherein the advancing mechanism is adapted for driving said print substrate upstream of a print station being adapted for printing said hot melt ink on a second surface of said print substrate downstream of the advancing mechanism, the advancing mechanism comprising a feed roller engaging the print substrate on a first surface of the print substrate for applying a driving force thereto and a pressure roller, being arranged opposite to the feed roller, the pressure roller having a textured outer surface, which texture is in operation in rolling contact with said second surface of the print substrate, wherein the texture of the outer surface is provided with a plurality of protrusions.

12. The printer according to claim 4, wherein the beads have a mean diameter in the range 0.1 and 0.4 mm.
